(19) United States
(12) Patent Application Publication
(10) Pub. No.: US 2017/0202135 A1
(43) Pub. Date: Jul. 20, 2017

(54) Material Spreader

(71) Applicant: Sides Spreader and Equipment Co., Inc., Welcome, NC (US)

(72) Inventors: Johnny Lee Sides, Winston Salem, NC (US); Jonathon Babek, Lebanon, NJ (US)

(21) Appl. No.: 14/995,381

(22) Filed: Jan. 14, 2016

(51) Int. Cl. A01C 17/00; A01C 15/00

(52) U.S. Cl. CPC A01C 17/001; A01C 15/007

(57) ABSTRACT

A material spreader has an auger drive assembly and a slinger disc that are simultaneously driven by a mule-drive assembly. The mule-drive assembly is configured to be connected to and powered by a power-take off drive of vehicle, such as a tractor. The auger drive assembly includes a concentric auger drive shaft disposed within a tubular auger shaft and a step-down gearbox. The auger drive shaft is connected to the input of the step-down gearbox and the tubular auger shaft is connected to the output of the same gearbox. This arrangement allows the tubular auger shaft to rotate at a slower speed than the auger drive shaft and provides a compact assembly of the material spreader.

### FIELD OF THE INVENTION

The present invention relates generally to material spreaders for use on farming equipment such as tractors, and more particularly, relating to an improved material spreader having a compact drive configuration that allows the spreader to be mounted closer to the center of gravity of the piece of farming equipment allowing the material spreader to hold a larger volume of material without rendering the farming equipment unstable.

### BACKGROUND OF THE INVENTION

For many years, material spreaders have been designed and operated to distribute seeds, fertilizer, and other granular material on to the land. The specific design of this equipment can vary from spreaders that hold large quantities of granular material and are towed behind tractors and other farming equipment, to containers that are attached to and are supported by the tractor and hold a smaller volume of material than a trailer design. Each design operates to distribute the granular material held in their respective containers over a specified area of land.

Generally, a material spreader has a container or a hopper and a spreader for distributing material, such as, for example seed that is placed into the hopper. When the material is placed into the hopper the material is either guided by a mechanical means, such as a conveyor, or simply by gravity into a hole on the bottom of the hopper. This hole allows the material to move from the hopper to the spreader where the material is then distributed across an area of land.

Current material spreader designs, specifically those that are mounted to and supported by a vehicle, do not allow for the spreader to be mounted in a way that allows for simultaneous operation of the spreader and the maximization of the weight that can be supported by the vehicle. Thus, there is a need for a new design of material spreader that allows the spreader to be mounted close enough to the back of a vehicle to maximize the amount of material contained in the spreader while still allowing the spreader to operate as intended and not jeopardizing the stability of the vehicle.

### SUMMARY OF THE INVENTION

In view of the foregoing problems with existing material spreaders, embodiments of the present invention provide a new material spreader that substantially departs from the concepts and designs of the prior art, and in doing so provides a new material spreader that can attach closer in proximity to a tractor and hold a larger volume and weight of granular material without decreasing the stability and maneuverability of the tractor it is attached to.

In general, in one aspect, a material spreader is provided having a tubular auger shaft that is supported for rotation about a first axis of rotation and an auger drive shaft that is disposed coaxially within the tubular auger shaft and is supported for rotation about the first axis of rotation. The auger drive shaft is operatively connected to an input of a gearbox and the tubular auger shaft is operatively connected to an output of the gearbox and rotates at a speed proportional to the rotational speed of the auger drive shaft.

In general, in another aspect, the material spreader includes a mule-drive assembly. The mule-drive assembly has a jackshaft supported for rotation about a second axis of rotation and is configured to be operatively connected at one end to a power take-off of a tractor to which the material spreader is mounted. The mule-drive assembly also includes a jackshaft pulley that is connected to the jackshaft for conjoined rotation with the jackshaft, a headstock shaft that is supported for rotation about the first axis of rotation, and a headstock pulley that is connected to the headstock shaft for conjoined rotation therewith. A drive belt is looped over the jackshaft pulley and the headstock pulley, wherein the rotation of the jackshaft causes rotation of the headstock shaft via the drive belt. The headstock shaft is operatively connected to the auger drive shaft so as to rotatably drive the auger drive shaft.

In general, in yet another aspect, the mule-drive assembly further includes a slinger shaft that is supported for rotation about a third axis of rotation, a slinger pulley attached to the slinger shaft for conjoined rotation therewith, and a mule-drive belt looped around the slinger pulley and the headstock pulley. The rotation of the jackshaft causes rotation of the slinger shaft via the mule-drive belt.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages, and the specific objects attained by its uses, reference should be had to the accompanying drawings and descriptive matter in which there are illustrated embodiments of the invention.

### BRIEF DESCRIPTION OF THE DRAWINGS

The following drawings illustrate by way of example and are included to provide further understanding of the invention for the purpose of illustrative discussion of the embodiments of the invention. No attempt is made to show structural details of the embodiments in more detail than is necessary for a fundamental understanding of the invention, the description taken with the drawings making apparent to those skilled in the art how the several forms of the invention may be embodied in practice. Identical reference numerals do not necessarily indicate an identical structure. Rather, the same reference numeral may be used to indicate a similar feature of a feature with similar functionality. In the drawings:

FIG. 1 is top-front perspective view of a material spreader constructed in accordance with the principles of an embodiment of the present invention

FIG. 2 is a front elevation view of the material spreader constructed in accordance with the principles of an embodiment of the present invention;

FIG. 3 is a cross-sectional view of the material spreader taken along the line 3-3 in FIG. 2;

FIG. 4 is a bottom-front perspective view of the material spreader constructed in accordance with the principles of an embodiment of the present invention;

FIG. 5 is top-rear perspective view of the material spreader constructed in accordance with the principles of an embodiment of the present invention;

FIG. 6 is a top plan view of the material spreader constructed in accordance with the principles of an embodiment of the present invention; and

FIG. 7 is a bottom plan view of the material spreader constructed in accordance with the principles of an embodiment of the present invention.

### DETAILED DESCRIPTION OF THE INVENTION

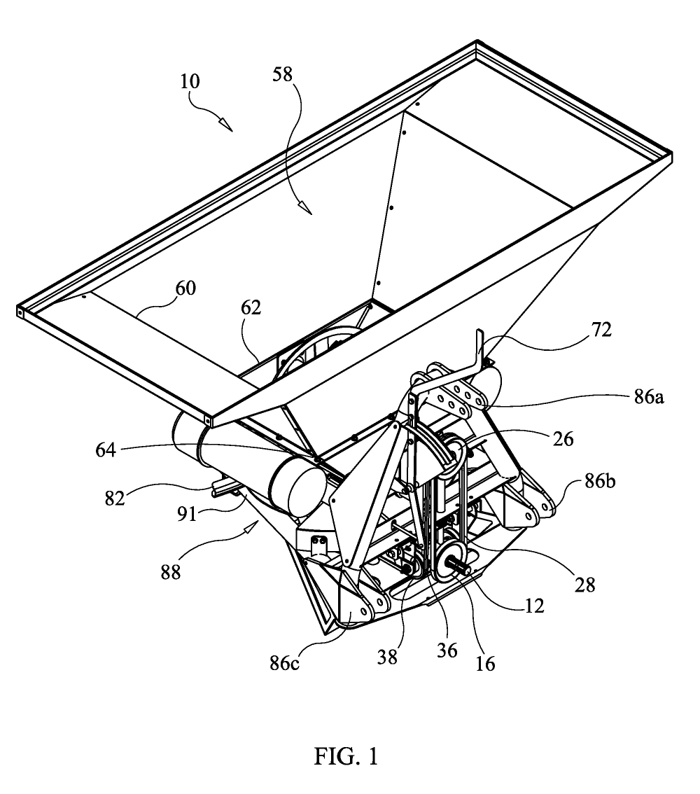

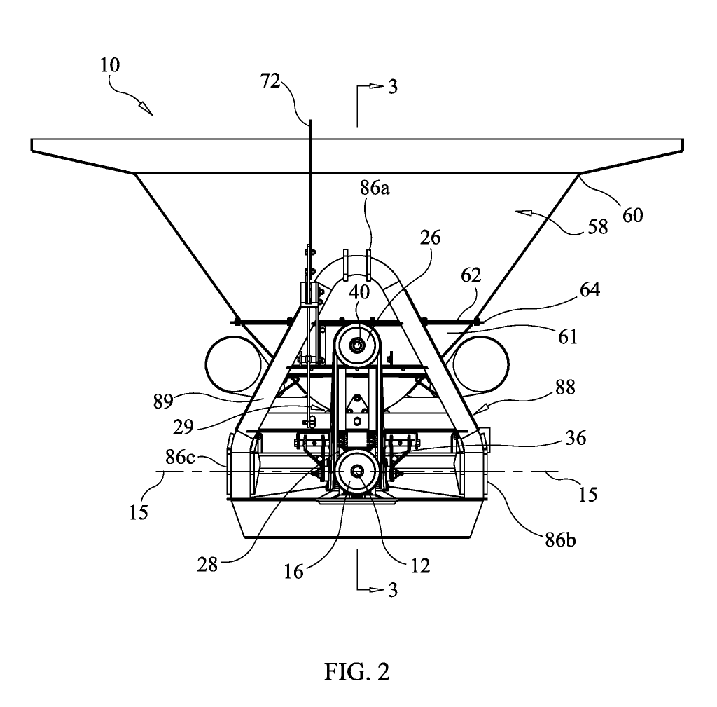

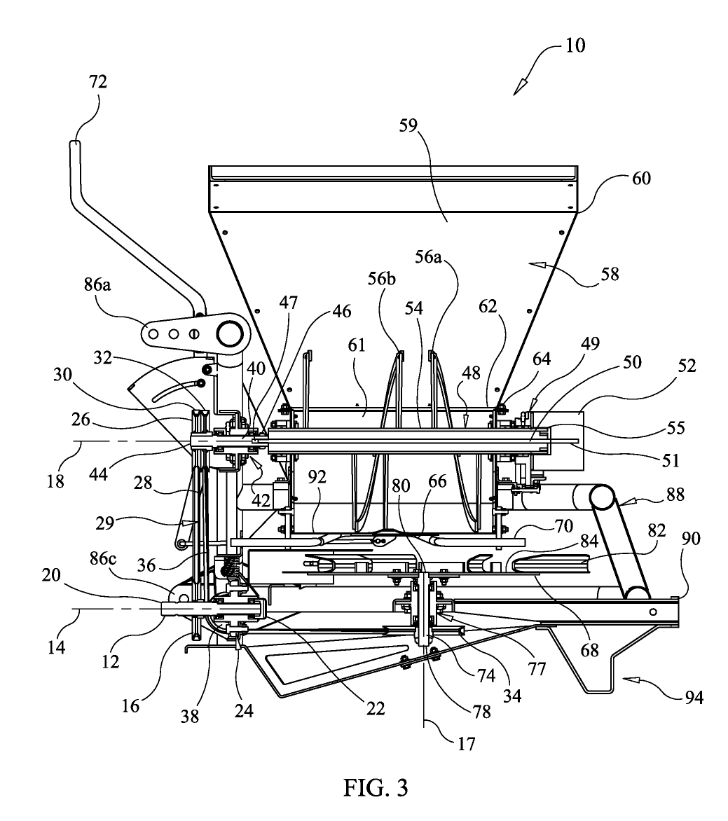

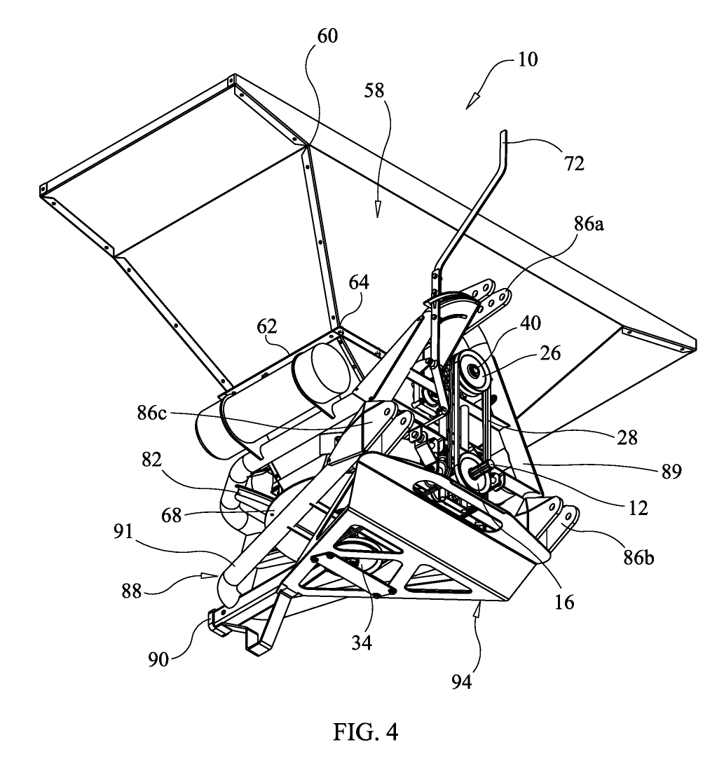

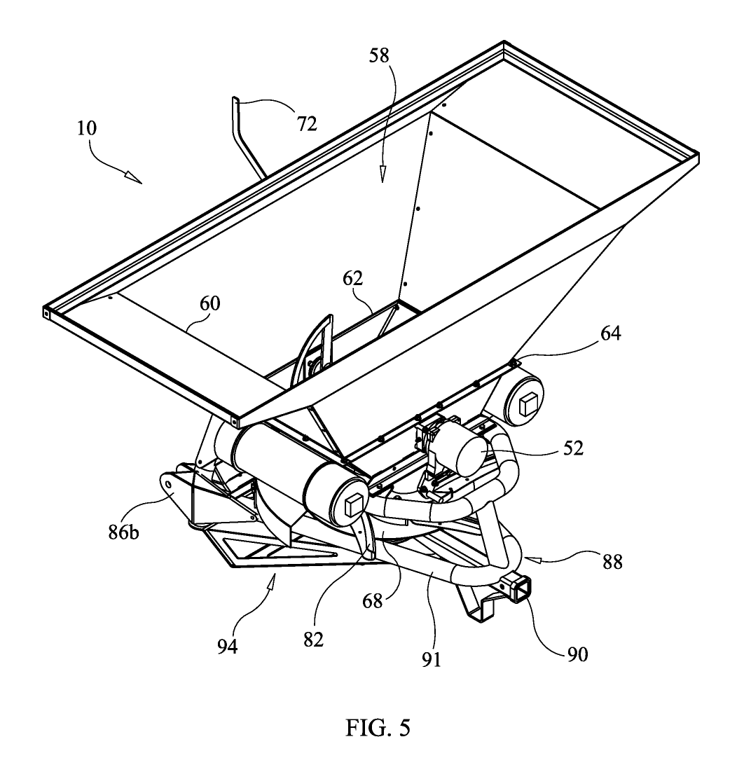

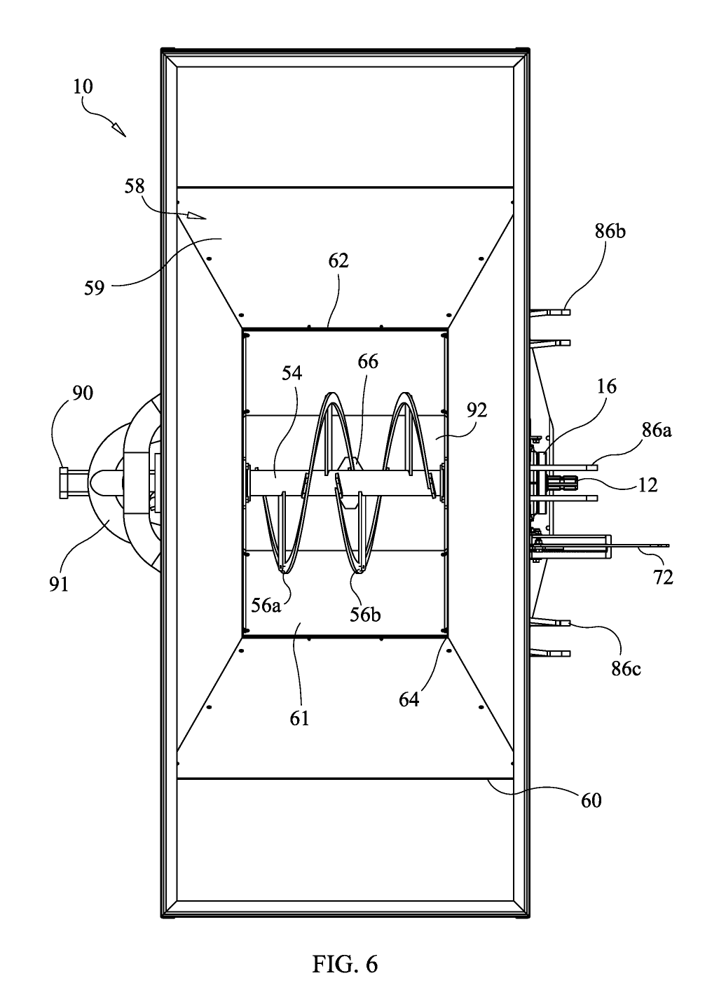

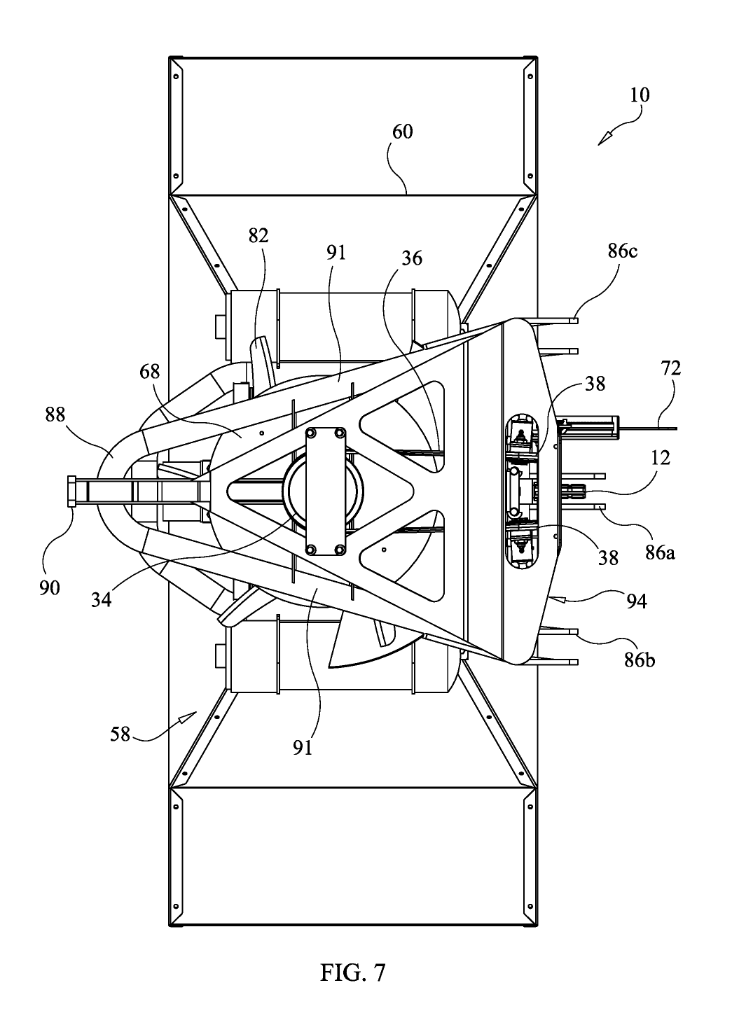

With reference to FIGS. 1-7, there is representatively illustrated a new material spreader that is constructed in accordance with an embodiment of the present invention and is designated by reference number 10. As discussed in more detail below, the material spreader 10 has an auger drive assembly 48 and a slinger disc 68 that are simultaneously driven by a mule-drive assembly 29, which is powered by a conventional power-take off drive of an industrial vehicle, such as a tractor.

The spreader 10 is supported by a rigid support frame 88 that is attached to a tractor by the tractor's three point hitch. The novel construction of the auger shaft assembly 48 and the mule-drive assembly 29 allows for the spreader 10 to be attached in close proximity to the tractor, thereby increasing the amount of weight of material the spreader can hold without sacrificing stability of the attached tractor.

In the representatively illustrated embodiment, the material spreader 10 has a rigid support frame 88 upon which the components of the material spreader are secured. The rigid support frame 88 includes hitch tabs 86a, 86b, and 86c that are configured to be removably connected to the three point hitch of a tractor. The support frame 88 includes horizontal frame members 91 that are attached to and extend perpendicularly from vertical frame members 89 to form a base 94 for the spreader 10. When not in use, the spreader 10 can be stabilized on the ground by the base 94. Additionally, the horizontal frame members 91 can be equipped with a receiver hitch 90 to allow the tractor to pull additional attachments behind the tractor.

The spreader 10 further includes a jackshaft 12 rotatably supported by bearing assembly 24 for rotation about axis 14. The bearing assembly 24 is disposed at end 22 of the jackshaft 12 and opposite end 20 of the jackshaft 12 is configured to be operatively connected to the power take-off of the tractor to be rotatably driven by the power take-off. A jackshaft pulley 16 is mounted to the jackshaft 12 between ends 20 and 22 for conjoined rotation with the jackshaft 12.

The mule-drive assembly 29 includes the jackshaft 12, the jackshaft pulley 16, a drive belt 28, a headstock pulley 26, a slinger pulley 34, a mule-drive belt 36, and a pair of idler pulleys 38. The jackshaft pulley 16 is operatively coupled to the headstock pulley 26 by the drive belt 28. The headstock pulley 26 can include a first belt groove 30 and a second belt groove 32, wherein the first belt groove 30 receives the drive belt 28 and the second belt groove is operatively coupled to the slinger pulley 34 by the mule-drive belt 36. Alternatively, the headstock pulley 26 could be replaced by two separate pulleys that are attached for conjoined rotation with one another.

The pair of idler pulleys 38 are rotatably supported on the frame 88 and positioned on either side of the bearing assembly 24. The pair of idler pulleys 38 are rotated about axis 15, or alternatively about an axis that is cambered relative to axis 15, to allow the mule-drive belt 36 to rotatably drive the headstock pulley 26 and the slinger pulley 34 about perpendicular axes 18 and 17, respectively.

The spreader 10 further includes the auger drive assembly 48. The auger drive assembly includes an auger drive shaft 50, a gearbox 52, and a tubular auger shaft 54. The auger drive shaft 50 has a first end 47 and a second end 51, wherein the first end 47 is operatively coupled to headstock shaft 40. The auger drive shaft 50 is concentrically disposed within the tubular auger shaft 54 and extends parallel along axis 18 from the first end 47 of the auger drive shaft 50 to the second end 51 of auger drive shaft 50.

The mule-drive assembly 29 includes a headstock shaft 40 that is rotatably supported by the second bearing assembly 42 for rotation about axis 18. The headstock shaft 40 has a first end 44 that is operatively connected to the headstock pulley 26 for conjoined rotation therewith. The headstock shaft 40 has a second end 46 that is operatively connected to the first end 47 of the auger drive shaft 50 so as to rotatably drive the auger drive shaft 50.

The material spreader 10 further includes a third bearing assembly 49 configured to rotatably support a second end 55 of the tubular auger shaft 54 and positioned at a location inward from the gearbox 52. The auger drive shaft 50 is operatively connected to the input of the gearbox 52 and the tubular auger shaft 54 is operatively connected to the output of the gearbox 52. Representatively, the gearbox 52 is a step-down gearbox wherein the auger drive shaft 50 rotates at a higher speed than the tubular auger shaft 54. A critical advantage of the material spreader 10 is the ability for the tubular auger shaft 54 to operate at a slower speed than that of the auger drive shaft 50, whereas a conventional spreader only allows the auger to rotate at a slightly slower speed than that of the tractor's power-take off. Other conventional spreader's augers are tied to the rotation of the material slinger drive, whereas the material spreader's 10 auger drive assembly 48 can operate independently of the slinger.

The material spreader 10 has a hopper 58 including an upper portion 59 and a lower portion 61. The upper portion 59 includes an upper-rectangular peripheral edge 60 that tapers to a lower-rectangular peripheral edge 62 wherein the upper-rectangular peripheral edge 60 is larger than the lower rectangular peripheral edge. The lower portion 61 attaches to the upper portion 59 at a hopper attachment point 64 and tapers from the lower-rectangular peripheral edge to a hopper base 92. Alternatively, the upper and lower portion 59 and 61 of the hopper 58 could be replaced by a hopper of unitary design.

The auger drive assembly 48 is disposed within the lower portion 61 of the hopper 58. The auger drive shaft 50 and the tubular auger shaft 54 extend across and through the lower portion 61 from the headstock shaft 40 to the gearbox 52 wherein the headstock shaft 40 and the gearbox 52 are located on opposite sides of the lower portion 61 of the hopper 58. The auger blades 56 are disposed within and extend across the hopper 58.

The material spreader 10 further includes a pair of helical shaped auger blades that are attached along the outer circumference of the tubular auger shaft 54. The auger blades include a left-handed auger blade 56a and a right-handed auger blade 56b. When the tubular auger shaft 54 is rotated, the auger blades 56a and 56b guide material disposed in the hopper 58 from the sides of the hopper to the material exit hole 66.

The material exit hole 66 is disposed within the hopper base 92. When the hopper 58 is filled with material, the shape of the hopper 58 and the auger blades 56 operate in conjunction to guide the material from the upper portion 59 to the lower portion 61 and then through the material exit hole 66. The material exit hole 66 allows the granular material to exit the hopper 58 at a single controlled location.

During operation, the material exit hole 66 can be opened and closed by a gate 70. The gate 70 is operatively connected to a gate lever arm 72 that can be operated by a user to open and close the material exit hole 66. When the gate 70 is closed, the auger drive assembly 48 and the auger blades 56 can continue to operate and mix material in the hopper 58. When the gate 70 is opened, the material passes from the lower portion 61, through the material exit hole 66 and onto a slinger disc 68. The gate 70 can be partially opened while the material spreader 10 is in operation to control the rate the material passes through the material exit hole 66.

The mule-drive assembly 29 further includes a slinger shaft 74 that is supported for rotation about axis 17 by a fourth bearing assembly 77, which is disposed between opposite ends 78 and 80 of the slinger shaft. The slinger pulley 34 is connected at the first end 78 of the slinger shaft 74 for conjoined rotation therewith.

The material spreader 10 further includes a slinger disc 68 that is connected at the second end 80 of the slinger shaft 74 for conjoined rotation therewith. In this manner, the slinger pulley 34 is driven by mule-drive belt 36, which in turn drives the slinger disc 68 via the slinger shaft 74. The slinger disc 68 has a top face 84 and includes slinger fins 82 positioned along the top face 84, which capture the material that has fallen through the material exit hole 66. As the slinger disc 68 rotates, centrifugal force is used to direct the material away from the material spreader 10.

A number of embodiments of the present invention have been described. Nevertheless, it will be understood that various modifications may be made without departing from the spirit and scope of the invention and the following claims.

What is claimed is:

1. A material spreader comprising:
a tubular auger shaft supported for rotation about a first axis of rotation;
an auger drive shaft disposed coaxially within said tubular auger shaft and supported for rotation about said first axis of rotation;
a gearbox, said auger drive shaft being operatively connected to an input of said gearbox and said tubular auger shaft being operatively connected to an output of said gearbox; and
wherein said tubular auger shaft rotates at a speed proportional to the rotational speed of said auger drive shaft.

2. The material spreader of claim 1, wherein said gearbox provides a step-down rotational speed between said input and said output.

3. The material spreader of claim 1, further comprising:
a mule-drive assembly having a jackshaft supported for rotation about a second axis of rotation and configured to be operatively connected at one end to a power take-off of a vehicle to which the material spreader is mounted; a jackshaft pulley connected to said jackshaft for conjoined rotation therewith; a headstock shaft supported for rotation about said first axis of rotation; a headstock pulley connected to said headstock shaft for conjoined rotation therewith; and a drive belt looped over said jackshaft pulley and said headstock pulley, wherein rotation of said jackshaft causes rotation of said headstock shaft via said drive belt; and
wherein said headstock shaft is operatively connected to said auger drive shaft so as to rotatably drive said auger drive shaft.

4. The material spreader of claim 3, wherein said mule-drive assembly further includes:
a slinger shaft supported for rotation about a third axis of rotation;
a slinger pulley attached to said slinger shaft for conjoined rotation therewith;
a mule-drive belt looped around said slinger pulley and said headstock pulley; and
wherein rotation of said jackshaft causes rotation of said slinger shaft via said mule-drive belt.

5. The material spreader of claim 4, further comprising:
a slinger disc attached to said slinger shaft for conjoined rotation therewith.

6. The material spreader of claim 4, wherein said first axis of rotation is generally parallel with said second axis of rotation, and said third axis of rotation is generally perpendicular to said first axis of rotation and said second axis of rotation.

7. The material spreader of claim 1, further comprising:
a right-handed and a left-handed auger blade attached to said tubular auger shaft; and
a hopper, said right-handed and said left-handed auger blade being disposed within said hopper.

8. A material spreader comprising:
a rigid frame;
a hopper connected to and supported by said rigid frame;
an auger drive assembly having a tubular auger shaft supported for rotation about a first axis of rotation; an auger drive shaft disposed coaxially within said tubular auger shaft and supported for rotation about said first axis of rotation; a gearbox, said auger drive shaft being operatively connected to an input of said gearbox and said tubular auger shaft being operatively connected to an output of said gearbox; and wherein said tubular auger shaft rotates at a speed proportional to the rotational speed of said auger drive shaft;
a mule-drive assembly having a jackshaft supported for rotation about a second axis of rotation and configured to be operatively connected at one end to a power take-off of a vehicle to which the material spreader is mounted; a jackshaft pulley connected to said jackshaft for conjoined rotation therewith; a headstock shaft supported for rotation about said first axis of rotation; a headstock pulley connected to said headstock shaft for conjoined rotation therewith; and a drive belt looped over said jackshaft pulley and said headstock pulley, wherein rotation of said jackshaft causes rotation of said headstock shaft via said drive belt;
wherein said headstock shaft is operatively connected to said auger drive shaft so as to rotatably drive said auger drive shaft; and
a right-handed and a left-handed auger blade attached to said tubular auger shaft, wherein said right-handed and said left-handed auger blade are disposed within said hopper.

9. The material spreader of claim 8, further comprising:
a slinger disc;
said mule-drive assembly further including a slinger shaft supported for rotation about a third axis of rotation; a slinger pulley attached to said slinger shaft for conjoined rotation therewith; a mule-drive belt looped around said slinger puller and said headstock pulley; and wherein rotation of said jackshaft causes rotation of said slinger shaft via said mule-drive belt; and
said slinger disc connected to said slinger shaft for conjoined rotation therewith.

10. The material spreader of claim 9, wherein said first axis of rotation is generally parallel with said second axis of rotation, and said third axis of rotation is generally perpendicular to said first axis of rotation and said second axis of rotation.

11. The material spreader of claim 8, further comprising:
first, second, and third hitch tabs connected to said rigid frame, each of said first, second, and third hitch tabs configured to be removably connected to a three-point hitch of a vehicle.

12. The material spreader of claim 8, wherein said tubular auger shaft and said auger drive shaft extend through a lower portion of said hopper.

13. The material spreader of claim 8, wherein said gearbox provides a step-down rotational speed between said input and said output.

14. The material spreader of claim 8, further comprising:
a gate movable between a first position where a material exit hole of said hopper is closed and a second position where said material exit hole is open; and
a gate lever operatively connected to said gate and operable to move said gate between said first and said second positions.
